(19) United States
(12) Patent Application Publication
(10) Pub. No.: US 2023/0096228 A1
(43) Pub. Date: Mar. 30, 2023

(54) LITHIUM ION SECONDARY BATTERY

(71) Applicant: TDK CORPORATION, Tokyo (JP)

(72) Inventors: Keitaro OTSUKI, Tokyo (JP); Kazumasa TANAKA, Tokyo (JP)

(73) Assignee: TDK CORPORATION, Tokyo (JP)

(21) Appl. No.: 17/794,355

(22) PCT Filed: Dec. 25, 2020
(86) PCT No.: PCT/JP2020/048845

§ 371 Date: Jul. 21, 2022

(30) Foreign Application Priority Data
Jan. 24, 2020 (JP) 2020-009573

(51) Int. Cl. H01M 10/0562; H01M 10/0525

(52) U.S. Cl. CPC H01M 10/0562; H01M 10/0525

(57) ABSTRACT

The lithium ion secondary battery wherein at least one positive electrode layer including a positive electrode active material layer and at least one negative electrode layer including a negative electrode active material layer are laminated in sequence with at least one solid electrolyte layer interposed therebetween, wherein a ratio t1/t2 of an average thickness t1 of the thickest solid electrolyte layer to an average thickness t2 of the thinnest solid electrolyte layer satisfies 1.02 ≤ t1/t2 ≤ 1.99 when an average thickness of each of the solid electrolyte layer is defined as t.

### TECHNICAL FIELD

The present invention relates to a lithium ion secondary battery.

Priority is claimed on Japanese Patent Application No. 2020-009573 filed on Jan. 24, 2020, the content of which is incorporated herein by reference.

### BACKGROUND ART

In recent years, developments in electronics technology have been remarkable, and portable electronic devices have become smaller and lighter, thinner, and more multifunctional. Along with that, there is a strong demand for batteries serving as power sources of electronic devices to be smaller and lighter, thinner, and more reliable.

Currently, in a commonly used lithium ion secondary battery for batteries of power supply for electronic devices, a liquid electrolyte (electrolytic solution) such as an organic solvent has been conventionally used as an electrolyte which is medium for moving ions. However, in a battery using a liquid electrolyte, there is a risk that the electrolyte may leak out due to external impact, and the battery function may drop. Therefore, it is required to further enhance the safety of batteries.

Therefore, as one of the measures for enhancing the reliable of lithium ion secondary batteries, the development of the lithium ion secondary battery, which use a solid electrolyte instead of a liquid electrolyte, place it between electrodes, laminate it and wind it, is progress.

However, it is known that the solid electrolyte has less ion conductivity comparing with the liquid electrolyte. Various studies for improving output characteristics of lithium ion secondary batteries are being done.

According to Patent Literature 1, it is disclosed that rate characteristics are improved by mixing solid electrolyte in the electrode and adjusting the ratio of solid electrolyte to the electrode active material and void ratio in the thickness direction.

According to Patent Literature 2, it is disclosed that charge/discharge efficiency are improved by mixing solid electrolyte in the electrode and controlling the difference between the resistivity due to ion transfer in the electrode and the resistivity due to the electron transfer to OkΩ·cm or more and 100kΩ·cm or less.

According to Patent Literature 3, it is disclosed that solid electrolyte film having superior battery characteristics can be gain when the standard deviation of the thickness of the electrolyte film is 5.0 µm or less.

### Citation List

### Patent Literature

[Patent Literature 1]

Japanese Unexamined Patent Application No. 2012-104270

[Patent Literature 2]

PCT International Publication No. WO 2014/002858

[Patent Literature 3]

Japanese Unexamined Patent Application No. 2017-157362

### SUMMARY OF INVENTION

### Technical Problem

However, as electronic devices become more multifunctional, the demand for lithium ion secondary batteries comprising a solid electrolyte and having higher output characteristics increases.

An objective of the present invention is to provide a lithium ion secondary battery having high output characteristics when solid electrolyte is used as electrolyte.

### Solution to Problem

As a result of diligent examination, the inventors clarified that making the thickness of multiple solid electrolyte layer in the thickness direction in the lithium ion secondary battery a specific ratio, the output characteristics increases and reach the present invention.

Therefore, the following solutions are provided to solve the above problems.

A lithium ion secondary battery according to an aspect of the present invention is a lithium ion secondary battery at least one positive electrode layer including a positive electrode active material layer and at least one negative electrode layer including a negative electrode active material layer are laminated in sequence with at least one solid electrolyte layer interposed therebetween, and a ratio tl/t2 of an average thickness t1 of the thickest solid electrolyte layer to an average thickness t2 of the thinnest solid electrolyte layer satisfies 1.02 ≤ tl/t2 ≤1.99 when an average thickness of each of the solid electrolyte layer is defined as t.

With the above configuration, output characteristics of the lithium ion secondary battery comprising solid electrolytes can be improved. It is based on the following principle. Compared with the case that the average thickness of the solid electrolyte layer comprised in the lithium ion secondary battery is uniform, the charge/discharge reaction in the positive electrode and the negative electrode via the solid electrolyte layer having a thin average thickness proceeds faster, and charge bias between the positive electrode layer and negative electrode layer in the lithium ion battery occurs. The charge bias facilitate the charge/discharge reaction in the solid electrolyte layer which has large average thickness.

By controlling the ratio of the average thickness of the solid electrolyte layer within the range of the present invention, charge bias in the positive electrode and the negative electrode is caused, suppressing the occurrence of heterogeneous reaction in the lithium ion secondary battery due to the difference in the average thickness of the solid electrolyte layer, and output characteristics is improved.

In the lithium ion secondary battery according to the above-described aspect, the standard deviation σ may satisfy 0.15 ≤ σ <1.66 (µm).

By comprising the above configuration, the occurrence of heterogeneous reaction in the lithium ion secondary battery is suppressed and high output characteristics can be obtained by generating an appropriate charge bias without bias inside the lithium ion secondary battery.

In the lithium ion secondary battery according to the above-described aspect, an intermediate layer may be comprised in at least one part between the positive layer or the negative layer and the solid electrolyte layer, which may include each constituent element of the positive layer or the negative layer and the solid electrolyte layer.

By comprising the above configuration, lithium ions are preferably exchanged at the interface between the positive electrode layer and the negative electrode layer and the solid electrolyte layer. That is, interface resistance drop noticeably, and the occurrence of bias charge and the progress of charge/discharge reaction is facilitated and high output characteristics is gained.

In the lithium ion secondary battery according to the above-described aspect, an average thickness T, which is an average of the average thickness t of each of the solid electrolyte layer, may satisfy 4.8≤T≤9.8 (µm).

By comprising the above configuration, lithium ions are preferably exchanged while sufficiently ensuring insulation between the positive electrode layer and the negative electrode layer. Therefore, high output characteristics can be obtained.

### Advantageous Effects of Invention

According to the present invention, it is possible to provide a lithium ion secondary battery having high output characteristics.

### BRIEF DESCRIPTION OF DRAWINGS

FIG. 1 is a cross-sectional view of a part of a lithium ion secondary battery according to an embodiment of the present invention in the lamination direction.

FIG. 2 is a cross-sectional view of a part of a lithium ion secondary battery according to a modification example of the present invention in the lamination direction.

### DESCRIPTION OF EMBODIMENTS

Hereinafter, one embodiment of the present invention will be described in detail with reference to the drawings as appropriate. In the drawings used in the following description, there are cases in which illustration is simplified for convenience so that characteristics of the present embodiment can be easily understood, and dimensional proportions or the like of respective components may be different from actual ones. Materials, dimensions, configuration, and the like exemplified in the following description are merely examples, and the present embodiment is not limited thereto and can be implemented with appropriate modifications within a range in which the effects of the present invention are achieved. For example, configurations described in different embodiments can be appropriately combined and implemented.

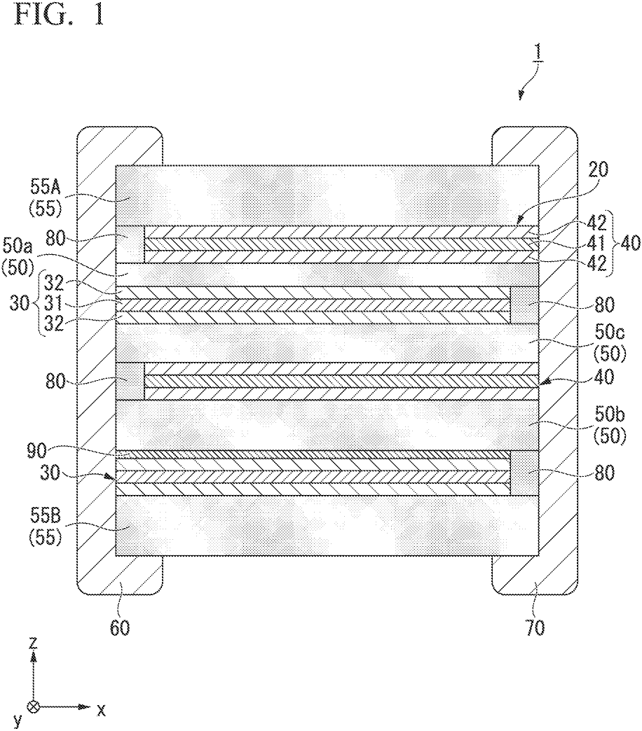

First, direction is defined as following. One direction of one surface of the positive electrode layer 30 (see FIG. 1) is defined as x direction, and the direction orthogonal to the x direction is defined as y direction. The x direction is, for example, a direction in which the outer positive electrode 60 and the outer negative electrode 70 sandwich the laminate 20. The x direction and the y direction are examples of the in-plane direction. The z direction is a direction orthogonal to the x direction and the y direction. The z direction is an example of the stacking direction. Hereinafter, the + z direction may be expressed as “up” and the -z direction may be expressed as “down”. The term up and down do not always match the direction in which gravity is applied.

### Lithium Ion Secondary Battery

First, the lithium ion secondary battery of the present embodiment is described as below.

As shown in FIG. 1, the lithium ion secondary battery 1 comprises laminate 20, in which the positive layer 30 and the negative layer 40 are laminated with the solid electrolyte layer 50 interposed therebetween. Laminates 20 is, for example, sandwiched between the outer layers 55, which will be described later, in the lamination direction. The positive layer 30 includes the positive electrode current collector layer 31 and the positive electrode active material layer 32. The negative layer 40 includes the negative electrode current collector layer 41 and the negative electrode active material layer 42.

The margin layer 80 is provided in the same plane of the positive layer 30 and the negative layer 40. The laminate 20 is a hexahedron and has two end faces formed as planes parallel to the stacking direction, two side surfaces, and an upper surface and a lower surface formed as faces orthogonal to the stacking direction. The positive current collector layer 31 is exposed on the first end surface. The negative current collector layer 42 is exposed on the second end surface.

The first end surface and the second end surface faces each other. The first side surface and the second side surface faces each other. Although it is described below, the positive current collector layer 31 and the negative current collector layer 41 are exposed on the first side surface and the second side surface respectively.

An outer positive electrode 60 connected to the positive electrode current collector layer 31 is attached so as to cover the first end surface of the laminate 20. It is noted that, this electrical connection is formed by connecting the outer positive electrode 60 with the positive current collector layer 31 of the positive electrode layer 30 which is exposed on the first end surface, the first side surface and the second side surface of the laminate 20.

An outer negative electrode 70 connected to the negative electrode current collector layer 41 is attached so as to cover the second end surface of the laminate 20. It is noted that, this electrical connection is formed by connecting the outer negative electrode 70 with the negative current collector layer 41 of the negative electrode layer 40 which is exposed on the second end surface, the first side surface and the second side surface of the laminate 20.

It is noted that, as a description in the following specification, either one or both of the positive electrode active material and the negative electrode active material may be collectively referred to as an active material, either one or both of the positive electrode active material layer 32 and the negative electrode active material layer 42 may be collectively referred to as an active material layer, either one or both of the positive electrode current collector layer 31 and the negative electrode current collector layer 41 may be collectively referred to as a current collector layer, either one or both of the positive electrode 30 and the negative electrode 40 are collectively referred to as an electrode, either one or both of the first end surface and the second end surface may be collectively referred to as an end surface, either one or both of the first side surface and the second side surface may be collectively called as side surface, and either one or both of the outer positive electrode 60 and the outer negative electrode 70 may be collectively referred to as an outer electrode.

The margin layer 80 of the lithium ion secondary battery 1 of the present embodiment is preferably provided when the either one or both of the steps is large for resolving the step between the solid electrolyte layer 50 and the positive electrode layer 30 and the step between the solid electrode layer 50 and the negative electrode layer 40. The margin layer 80 is preferably provided in the same plane of the positive electrode layer 30 and the negative electrode layer 40. Providing the margin layer 80 can resolve the step between the solid electrolyte layer 50 and the positive electrode layer 30 and the solid electrolyte layer 50 and the negative electrode layer 40. Therefore, the elaborateness between the solid electrolyte layer 50 and the electrode layers gets higher and peeling between the delamination and warpage caused by the firing of the lithium ion secondary battery are less likely to occur.

### Solid Electrolyte Layer

The solid electrolyte layer 50 of the lithium ion secondary battery 1 of the present embodiment is sandwiched between the positive electrode layer 30 and the negative electrode layer 40 in z direction. In FIG. 1, an aspect which three solid electrolyte layer 50a, 50b, 50c are provided are exemplified. The solid electrolyte layer 50a is the thinnest solid electrolyte layer, the solid electrolyte layer 50b is the thickest solid electrolyte layer, and the solid electrolyte layer 50c has the thickness which is the thickness between the thickness of the solid electrolyte layer 50a and the solid electrolyte layer 50b. It is noted that the size relationship of the thickness is judged based on the average thickness of each of the solid electrolyte layer 50.

A ratio tl/t2 of an average thickness t2 of the thinnest solid electrolyte layer 50a to an average thickness t1 of the thickest solid electrolyte layer 50b satisfies 1.02 ≤ tl/t2 ≤1.99. Here, the average thickness of the solid electrolyte layer 50 above is the average thickness in the in-plane of specific one solid electrolyte layer 50, and, for example, the average thickness in the x direction. It is noted that, in FIG. 1, an aspect that two solid electrolyte layer 50 which sandwich the positive electrode layer 30, the negative electrode layer 40 and the solid electrolyte layer 50b have the same thickness, and the thickness of the sandwiched solid electrolyte layer has thin thickness is exemplified. However, the thickness thereof may be different and the sandwiched solid electrolyte layer may have large thickness.

By comprising the above configuration, it is possible to improve the output of the lithium ion secondary battery comprising the solid electrolyte. It is based on the following principle. Compared with the case that the average thickness of the solid electrolyte layer comprised in the lithium ion secondary battery is uniform, the charge/discharge reaction in the positive electrode and the negative electrode via the solid electrolyte layer having a thin average thickness proceeds faster, and charge bias between the positive electrode layer and negative electrode layer in the lithium ion battery occurs. The charge bias facilitate the charge/discharge reaction in the solid electrolyte layer which has large average thickness.

By controlling the ratio of the average thickness of the solid electrolyte layer 50a, which is the thinnest, and the solid electrolyte layer 50b, which is the thickest, within the range of the present invention, charge bias between the positive electrode and the negative electrode is caused, suppressing the occurrence of heterogeneous reaction in the lithium ion secondary battery due to the difference in the average thickness of the solid electrolyte layer 50, and output characteristics is improved.

In the present embodiment, in the solid electrolyte layers 50, a ratio tl/t2 of an average thickness t2 of the thinnest solid electrolyte layer 50a to an average thickness t1 of the thickest solid electrolyte layer 50b is preferably in the range of 1.02<tl/t2<1.99.

By adjusting tl/t2 in the above range, the difference of the charge bias between the positive electrode and the negative electrode become small and as a whole lithium ion secondary battery, the charge bias between the positive electrode layer and the negative electrode layer becomes close. Therefore, the occurrence of heterogeneous reaction inside of the lithium ion secondary battery is suppressed and output characteristics is improved.

The average thickness of each of the solid electrolyte layer included in the solid electrolyte layer 50 is obtained by observing the cross section of the lithium ion secondary battery 1 by SEM. In the cross-section of lithium ion secondary battery 1, the average value of the thickness at the five points that divide the solid electrolyte layer 50 into approximately 6 equal parts is defined as the average thickness of the solid electrolyte layer 50, and the thickness of the solid electrolyte layer 50b having the thickest average thickness is defined as t1 and the thickness of the solid electrolyte layer 50b having the thinnest average thickness is defined as t2.

In the solid electrolyte layer 50 of the present embodiment, the standard deviation σ of the average thickness t of all of the solid electrolyte layer preferably satisfies 0.15<σ<1.66 (µm).

By comprising the above configuration, the occurrence of heterogeneous reaction in the lithium ion secondary battery the occurrence of heterogeneous reaction in the lithium ion secondary battery is suppressed and high output characteristics can be obtained by generating an appropriate charge bias without bias inside the lithium ion secondary battery.

In the solid electrolyte layer 50 of the present embodiment, the standard deviation σ of the average thickness t of all of the solid electrolyte layer more preferably satisfies 0.55<σ<1.24 (µm).

In the lithium ion secondary battery according to the above-described aspect, an average thickness T, which is an average thickness of the average thickness t of each of the solid electrolyte layer 50, preferably satisfies 4.8<T<9.8 (µm).

By comprising the above configuration, lithium ions are preferably exchanged while sufficiently ensuring insulation between the positive electrode layer and the negative electrode layer. Therefore, high output characteristics can be obtained.

The solid electrolyte layer 50 of the present embodiment is composed mainly of the solid electrolyte. As the solid electrolyte, heretofore known materials can be used, for example, Titanium Phosphate Aluminum Lithium Li₁+ₓAlₓTi₂₋ₓ (P0₄)₃ (0<_x<0.6), Germanium Phosphate Lithium Li_{1.5}Ge_{2.0}(PO₄)₃, Germanium Phosphate Aluminum Lithium Li_{1.5}Al_{o.5}Ge_{1.5}(P04)₃, Li₃₊ₓ₁Siₓ₁P1.ₓ₁O₄ (0.4<xl<0.6), Li₃.₄ V₀.₄Ge₀.₆O₄, Lithium Phosphate (LiGe₂(PO₄)₃, Li₂O—V₂O₅—SiO₂, Li₂O—P₂O₅—B₂O₃, Li₃PO₄, Li₀₅La₀₅TiO₃, Li₁₄Zn(GeO₄)₄, Li₇La₃ZrO₁₂, Li₃.₆Siₒ_{.6}P₀.₄O₄, Li₃BO₃—Li₂SO₄ glass ceramic, Li₃BO₃—Li₂SO₄—Li₂CO₃ glass ceramic, polyethylene oxide and the like can be used.

As long as the characteristics of the solid electrolyte can be obtained, a solid electrolyte whose composition ratio is changed by changing the composition ratio or substituting a different element may be used.

The solid electrolyte layer 50 of the present embodiment preferably contains phosphoric acid compounds such as titanium aluminum lithium phosphate and germanium aluminum lithium phosphate or oxides such as Li_{O.5}Lao.₅TiO3 and Li₃.₆Siₒ.₆Pₒ.₄O₄ as the solid electrolyte.

In the solid electrolyte which compose the solid electrolyte layer 50 of the present embodiment, the main component means the component having the highest composition ratio as a component occupying the solid electrolyte layer 50.

As the accessory components, which is comprised in the solid electrolyte layer 50 of the present embodiment, a sintering filling agent used when producing the solid electrolyte layer, decomposition product thereof, and the like are exemplified.

### Positive Electrode Layer and Negative Electrode Layer

A plurality of the positive electrode layers 30 and the negative electrode layers 40 are comprised in the laminate 20. The positive electrode layers 30 and the negative electrode layers 40 are laminated alternatively with the solid electrolyte layer interposed therebetween.

The positive electrode layer 30 comprises the positive current collector layer 31 and the positive electrode active material layer 32 which includes the positive electrode active material. The negative electrode layer 40 comprises the negative current collector layer 41 and the negative electrode active material layer 42 which includes the negative electrode active material.

The positive electrode current collector layer 31 and the negative electrode current collector layer 41 are excellent in conductivity. The positive electrode current collector layer 31 and the negative electrode current collector layer 41 is, for example, any of silver, palladium, gold, platinum, aluminum, copper, nickel. Copper does not easily react with positive electrode active materials, negative electrode active materials and solid electrolytes. For example, when copper is used for the positive electrode current collector layer 31 and the negative electrode current collector layer41, the internal resistance of the lithium ion secondary battery 1 can be used. The substance constituting the positive electrode current collector layer 31 and the negative current collector layer 41 may be the same of different.

The positive electrode active material layer 32 is formed on either or both side of the surface of the positive current collector layer 31. The positive electrode active material layer 32 may not be formed on the surface of the positive electrode current collector layer 31 on the side where the opposing negative electrode layer 40 does not exist. The negative electrode active material layer 42 is formed on either or both side of the surface of the negative electrode current collector layer 41. The neative electrode active material layer 42 may not be formed on the surface of the neative electrode current collector layer 41 on the side where the opposing positive electrode layer 30 does not exist. For example, on one side of the positive electrode layer 30 or the negative electrode layer 40 which is provided in the uppermost or the lowermost layer of the laminate 20, the positive electrode active material layer 32 or the negative electrode active material layer 42 may not be formed.

The positive electrode active material layer 32 and the negative electrode active material layer 42 includes positive electrode active materials or negative electrode active material that transfer electrons. In addition, a conductive auxiliary agents, ion guiding auxiliary agents, binder and the like can be included. It is preferable that the positive electrode active material and the negative electrode active material can efficiently inser and desorb lithium ions.

As the positive electrode active material layer and the negative electrode active material layer, generally known materials can be used, for example, transition metal oxide and transition metal composite oxide can be used. Examples of the positive electrode active material and the negative electrode active material are specifically, lithium manganese composite oxide Li2MnₐM_{a1–}ₐO₃ (0.8<a<1, Ma = Co, Ni), lithium cobaltite (LiCoO₂), lithium nickelate (LiNiO₂), lithium manganese spinel (LiMn₂O4), general formula: LiNiₓCo_{y}Mn_{z}O₂ (A composite metal oxide represented by x+y+z=1, 0<x<1, 0<y<1, 0<z<1), a lithium vanadium compound (LiV₂O₅), and an olivine type LiMbPO₄ (here, Mb is at least one elements selected from the group consisting of Co, Ni, Mn, Fe, Mg, Nb, Ti, Al, Zr), lithium vanadium phosphate (Li₃V₂(PO₄)₃ or LiVOP0₄), Li excess solid solution positive electrode represented by Li₂MnO₃—LiMcO₂ (Mc═ Mn, Co, Ni), lithium titanate (Li₄Ti₅O₁₂), titanium oxide (TiO₂) LiₛNiₜCoᵤAlᵥO₂ (0.9<s<1.3, 0.9<t+u+v< 1.1) composite Metal oxides, and the like.

It is noted that, as the positive electrode active material and the negative electrode active material, an olivine type LiMbPO₄ (here, Mb is at least one elements selected from the group consisting of Co, Ni, Mn, Fe, Mg, Nb, Ti, Al, Zr) or lithium vanadium phosphate (Li₃V₂(PO₄)₃ or LiVOPO₄) is preferably used.

As the positive electrode active material layer and the negative electrode active material layer, a positive electrode active material layer and the negative electrode active material layer whose composition ratio is changed by changing the composition ratio or substituting a different element may be used.

In the positive electrode active material and the negative electrode active material each of which compose the positive electrode layer 30 and the negative electrode layer 40 of the present embodiment, the main component means the component having the highest composition ratio as a component occupying the positive electrode active material or the negative electrode active material.

As the conductive auxiliary agents, for example, carbon materials such as carbon black, acetylene black, ketjen black, carbon nanotubes, graphite, graphene and activated carbon, and metal materials such as gold, silver, palladium, platinum, copper and tin can be used.

The ion guiding auxiliary agents are, for example, solid electrolyte. As the solid electrolyte, specifically, the same material as the material used for the solid electrolyte layer 50 can be used.

When the solid electrolyte is used as the ion guiding auxiliary agent, the solid electrolyte used for the ion guiding auxiliary agents is preferably the same as the solid electrolyte used for the solid electrolyte layer 50.

Also, when solid electrolyte is used as the ion guiding auxiliary agent, different solid electrolyte may be used for the positive electrode active material layer 32 and the negative electrode active material layer 42.

Here, there is no clear discrimination between the active materials that configure the positive electrode active material layer 32 and the negative electrode active material layer 42, and it is possible to compare the potentials of two kinds of compounds, that is, a compound in the positive electrode active material layer and a compound in the negative electrode active material layer, use a compound exhibiting a higher potential as the positive electrode active material and use a compound exhibiting a lower potential as the negative electrode active material.

### Positive Electrode Current Collector Layer and Negative Electrode Current Collector Layer

As the material which composes the positive electrode current collector layer 31 and the negative electrode current collector layer 41 of lithium ion secondary battery 1, the material with high conductivity is preferably used, for example, silver, palladium, gold, platinum, aluminum, copper, nickel and the like is preferably used. Especially, copper is more preferable because it does not easily react with the oxide-based lithium ion conductor and has the effect of reducing the internal resistance of the laminated all-solid-state battery. As the positive electrode current collector layer 31 and the negative electrode current collector layer 41, the same material may be used or different materials may be used.

Further, the positive electrode current collector layer 31 and the negative electrode current collector layer 41 may contain a positive electrode active material and a negative electrode active material, respectively. The content ratio of the active material in each of the current collector is not particularly limited. For example, in the volume ratio, positive current collector layer/ positive active material layer or negative current collector layer/ negative active material layer is preferably in the range of 90/10 to 70/30.

When the positive current collector layer 31 and the negative current collector layer 41 respectively contains the positive active material layer and negative and a negative electrode active material, this is desirable because adhesion between the positive electrode current collector layer 31 and the positive electrode active material layer 32 and between the negative electrode current collector layer 41 and the negative electrode active material layer 42 is improved.

### Intermediate Layer

In the lithium ion secondary battery 1, the intermediate layer 90 may be exist either one part of between the positive electrode layer 30 and the solid electrolyte layer 50, and between the negative electrode layer 40 and the solid electrolyte layer 50. In FIG. 1, although the example the intermediate layer 90 exists between the surface of the lowermost positive electrode layer 30 in z direction and the solid electrolyte layer 50b is shown, the number and the position of the intermediate layer 90 formed are not limited to the example.

The intermediate layer 90 of the present embodiment is preferably the layer which contains the constituent element of the positive electrode layer 30 or the negative electrode layer 40 and the constituent element of the solid electrolyte layer 50.

When the intermediate layer 90 contains the constituent element of the positive electrode layer 30 or the negative electrode layer 40 and the constituent element of the solid electrolyte layer 50, the positive electrode layer 30, the negative electrode layer 40, the solid electrolyte layer 50, and the intermediate layer 90 are compatible with each other to reduce the interfacial resistance, further promote the generation of charge bias and the subsequent progress of the charge/ discharge reaction, and high output characteristics can be obtained.

### Margin Layer

The margin layer 80 of the lithium ion secondary battery 1 of the present embodiment is preferably provided to eliminate a step between the solid electrolyte layer 50 and the positive electrode layer 30 and a step between the solid electrolyte layer 50 and the negative electrode layer 40. Since the steps between the solid electrolyte layer 50, and the positive electrode layer 30 and the negative electrode layer 40 are eliminated due to the presence of the margin layers 80, denseness of the laminate 20, the positive electrode layers 30, and the negative electrode layers 40 are increased, and delamination and warpage due to calcination of the lithium ion secondary battery 1 do not easily occur.

A material forming the margin layer 80 preferably contains, for example, the same material as the solid electrolyte layer 50.

The solid electrolyte which compose the margin layer 80 is preferably the same configuration that of the solid electrolyte which constitute the solid electrolyte layer 50.

### Outermost Layer

In the lithium ion secondary battery 1 of the present embodiment, outer layer (cover layer) 55 can be provided on both main surfaces of the laminate 20 exposed in the z direction, if necessary. In the present embodiment, the outer layer on the upper side in the stacking direction is referred to as the first outer layer (outermost layer on the upper surface) 55A, and the outer layer on the lower side in the stacking direction is referred to as the second outer layer (outermost layer on the lower surface) 55B. As the outer layer 55, the same material as the solid electrolyte layer can be used, but the outer layer 55 is not included in the solid electrolyte layer of the present embodiment.

### Manufacturing Method of Lithium Ion Secondary Battery

The lithium ion secondary battery 1 of the present embodiment can be manufactured by the following procedure. Each material of the positive electrode current collector layer 31, the positive electrode active material layer 32, the solid electrolyte layer 50, the negative electrode current collector layer 41, the negative electrode active material layer 42, the margin layer 80 and the intermediate layer 90 is made into a paste. A method of making each material into a paste is not particularly limited, and for example, powders of each material can be mixed with a vehicle to obtain a paste. Here, the vehicle refers to a collective term for a medium in a liquid phase, and a solvent, a binder, and the like are included therein. A binder contained in a paste for forming a green sheet or a printing layer is not particularly limited, but a polyvinyl acetal resin, a cellulose resin, an acrylic resin, an urethane resin, a vinyl acetate resin, a polyvinyl alcohol resin, or the like can be used, and at least one of these resins can be contained in a slurry.

The paste may contain a plasticizer. Types of the plasticizer are not particularly limited, but phthalates such as dioctyl phthalate and diisononyl phthalate, or the like may be utilized.

By such a method, a positive electrode current collector layer paste, a positive electrode active material layer paste, a solid electrolyte layer paste, a negative electrode active material layer paste, a negative electrode current collector layer paste, a margin layer paste, and an intermediate layer paste are made.

The manufactured solid electrolyte layer paste is applied on a substrate such as polyethylene terephthalate (PET) to a desired thickness and is dried as necessary to obtain a green sheet 5 for a solid electrolyte. A method of making the green sheet 5 for a solid electrolyte is not particularly limited, and known methods such as a doctor blade method, a die coater, a comma coater, and a gravure coater can be employed. Next, the intermediate layer paste 90, the positive electrode active material layer 32, the positive electrode current collector layer 31, and the positive electrode active material layer 32 are printed and laminated in order on the green sheet 5 by screen printing to form the intermediate layer 90 and the positive electrode layer 30. Next, in order to fill a step between the green sheet 5 for a solid electrolyte and the positive electrode layer 30, the margin layer 80 is formed by screen printing in a region other than the positive electrode layer to obtain a positive electrode unit.

The negative electrode unit can also be made through the same method as that of the positive electrode unit. The negative layer 40 and the margin layer 80 is formed by screen printing on a green sheet 5 to form a negative electrode unit.

At this time, by adjusting the coating thickness of the solid electrolyte layer paste, the positive electrode layer unit and the negative electrode layer unit having different thickness of the solid electrolyte layers are produced.

Then, the positive electrode unit and the negative electrode unit are laminated while being alternately offset so that one end of the positive electrode and one end of the negative electrode do not overlap each other. Further, outer layers can be provided on the laminated substrate on both main surfaces of the laminate as necessary. It is noted that, the same material as the solid electrolyte can be used for the outer layer. The sheet used for forming the outer layer is referred to as the sheet for outermost layer hereinafter. It is noted that, the outer layer is not included in the solid electrolyte layer 50 of the laminate 1.

The manufacturing method described above is for manufacturing the lithium ion secondary battery of a parallel type, and in a manufacturing method for a lithium ion secondary battery of a series type, the lamination may be made so that one end of the positive electrode and one end of the negative electrode match each other, that is, without them being offset.

Further, the manufactured laminated substrate can be collectively pressed by a die press, a hot water isotropic pressure press (WIP), a cold water isotropic pressure press (CIP), a hydrostatic pressure press, or the like to improve the adhesion. Pressurization is preferably performed while heating, and can be performed, for example, at 40 to 95° C. In the manufacturing method of the lithium ion secondary battery of the present embodiment, a laminated substrate may be produced in advance considering the position in the z direction to be cut later, and the laminated substrate may be cut at a predetermined position in the z direction to obtain a plurality of desired laminates.

The manufactured laminated substrate can be cut into the laminate of an uncalcined lithium ion secondary battery using a dicing device.

The laminate is sintered by debinding and calcining the laminate of the lithium ion secondary battery. In the debinding and calcination, the calcination can be performed at a temperature of 600° C. to 1000° C. in a nitrogen atmosphere. A retaining time for the debinding and calcination is, for example, 0.1 to 6 hours.

Further, outer electrodes can be provided to efficiently draw a current from the laminate 20 of the lithium ion secondary battery 1. In the outer electrodes, the positive electrode layer 30 and the negative electrode layer 40 are alternately connected in parallel, and are joined via two facing end faces E1 and E2 of the laminate and a part of two facing side surfaces S1 and S2. In this way, a pair of external electrodes are formed so as to sandwich the end faces of the laminate. As a method of forming the outer electrode 12, a sputtering method, a screen printing method, a dip coating method, or the like can be exemplified. In the screen printing method and the dip coating method, an outer electrode paste containing a metal powder, a resin, and a solvent is made to be formed as an outer electrode 12. Next, a baking process for removing the solvent and a plating treatment for forming a terminal electrode on a surface of the outer electrode are performed. On the other hand, in the sputtering method, the outer electrode and the terminal electrode can be directly formed, and thus the baking process and the plating treatment are not required.

The laminate of the lithium ion secondary battery 1 described above may be sealed in, for example, a coin cell to enhance humidity resistance and impact resistance. A sealing method thereof is not particularly limited, and for example, the laminate after calcination may be sealed with a resin. An insulator paste having an insulating property such as Al₂O₃ may be applied or dip-coated around the laminate, and the insulator paste may be heat-treated for the sealing.

In the above-described embodiment, a manufacturing method of a lithium ion secondary above battery having a process of forming a margin layer using the margin layer paste has been exemplified, but the manufacturing method of a lithium ion secondary battery according to the present embodiment is not limited to the example. For example, the process of forming the margin layer using the margin layer paste may be omitted. The margin layer may be formed by, for example, deforming the solid electrolyte layer paste in the manufacturing process of the lithium ion secondary battery.

### Modified Example

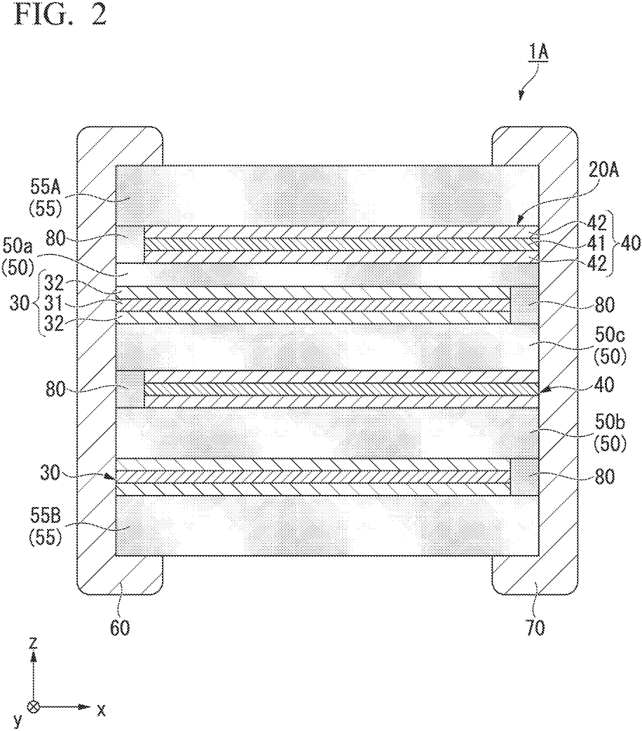

FIG. 2 is a cross-sectional view of a part of a lithium ion secondary battery 1A according to a modification example of the present invention in the lamination direction. In the lithium ion secondary battery 1A, the same configurations as the lithium ion secondary battery 1 are referred as the lithium ion secondary battery 1, and the description thereof are omitted.

The lithium ion secondary battery 1A shown in FIG. 2 is different from the lithium ion secondary battery 1 shown in FIG. 1 in that it does not comprises the intermediate layer 90.

The lithium ion secondary battery 1A can gain the same effect as the lithium ion secondary battery 1.

The specific example of lithium ion secondary battery according to the present embodiment have been described in detail above. The characteristic configurations of the embodiments may be combined each other.

### EXAMPLES

Hereinafter, the present invention will be described in more detail using examples and comparative examples on the basis of the above-described embodiments.

### Example 1

### Manufacture of Active Material Powder

Lithium vanadium phosphate prepared by the following method was used as the active material powder. As a production method thereof, Li₂CO₃, V₂O₅, and NH₄H₂PO₄ were used as starting materials, dispersed in pure water, and then wet-mixing was performed with a ball mill for 12 hours. After mixing, the powder obtained after dehydration drying was temporarily calcined at 850° C. for two hours in a nitrogen-hydrogen mixed gas. After temporarily calcined, it was dispersed in pure water, and then wet pulverized with a ball mill for 1 hour. After pulverization, it was dehydrated and dried to obtain lithium vanadium phosphate as an active substance powder.

As a result of analysis for the obtained active material with X-ray diffractometer, it was ascertained that the active material was vanadium lithium phosphate having a crystal architecture corresponding that of NASICON type Li₃V2(PO₄)₃.

### Manufacture of Active Material Layer Paste

A active material paste was made by adding 15 parts of ethyl cellulose as a binder and 65 parts of dihydroterpineol as a solvent to 100 parts of powders of the active material obtained together, and mixing and dispersing them.

### Manufacture of Solid Electrolyte Layer Paste-01

As the solid electrolyte, a solid electrolyte powder-01, which was made as below, was used. The way to make it is that, using Li₂CO₃, AI₂O₃, TiO₂, and NH₄H₂PO₄ as starting materials, the starting materials were dispersed in pure water, and then wet-mixing was performed with a ball mill for 12 hours. After mixing, the powder obtained after dehydration drying was temporarily calcined at 800° C. for two hours in the atmosphere. After temporarily calcined, it was dispersed in pure water, and then wet pulverized with a ball mill for 8 hours. After pulverization, it was dehydrated and dried to obtain solid electrolyte powder-01.

As a result of analysis for the obtained solid electrolyte powder-01 with X-ray diffractometer, it was ascertained that it was lithium aluminum phosphate having a crystal structure corresponding that of NASICON type LiTi₂ (P0₄)₃.

Next, 100 parts of ethanol and 200 parts of toluene as solvents were added to 100 parts of the solid electrolyte powder-01, and this was wet-mixed with a ball mill. Thereafter, 16 parts of a polyvinyl butyral-based binder and 4.8 parts of benzyl butyl phthalate were added and wet-mixed with a ball mill to obtain a solid electrolyte layer paste-01.

### Manufacture of Solid Electrolyte Layer Sheet-01

Using the obtained solid electrolyte paste-01, a sheet was formed using a PET film as a base by a doctor blade method to obtain a solid electrolyte layer. In this case, by adjusting the thickness in the range of 5 to 15 µm, a plurality of solid electrolyte sheets-01 having different thicknesses were prepared.

### Manufacture of Outermost Layer Sheet-01

A sheet of the outermost layer was made using a PET film as a base material and using a manufactured solid electrolyte layer paste-01 by doctor blade method to form a sheet having a thickness of 30 µm and an outermost layer sheet-01 was obtained.

### Manufacture of Current Collector Layer Paste

As a current collector, Cu powder and the manufactured powders of the positive electrode active material and the negative electrode active material were mixed to have a volume ratio of 80/20, thereafter 10 parts of ethyl cellulose as a binder and 50 parts of dihydroterpineol as a solvent were added to 100 parts of the mixture, and mixed and dispersed to obtain a positive electrode current collector layer paste and a negative electrode current collector layer paste.

### Manufacture of Margin Layer Paste-01

Next, 100 parts of ethanol and 100 parts of toluene as solvents were added to 100 parts of the the solid electrolyte powder-01, and this was wet-mixed with a ball mill. Thereafter, 16 parts of a polyvinyl butyral-based binder and 4.8 parts of benzyl butyl phthalate were added and wet-mixed with a ball mill to obtain a margin layer paste-01.

### Manufacture of Outer Electrode Paste

An Ag powder, an epoxy resin, and a solvent were mixed and dispersed with a ball mill to obtain an outer electrode paste of a thermosetting type.

Using these pastes, the lithium ion secondary battery was manufactured as the following procedure.

### Manufacture of Electrode Layer Unit

An active material layer was printed and formed on a main surface of the solid electrolyte layer sheet-01 using a screen printing machine, and dried at 80° C. for 10 minutes. A current collector layer having the thickness of 5 µm was printed and formed on the active material layer, and dried at 80° C. for 10 minutes. Further, an active material layer having the thickness of 5 to 10 µm was printed and formed again on the current collector layer and dried at 80° C. for 10 minutes, and thereby an electrode layer was formed on the solid electrolyte layer sheet-01. Next, a margin layer having a height substantially equal to that of the electrode layer was formed on the outer periphery of one end of the electrode layer by screen printing, and dried at 80° C. for 10 minutes. Next, the PET film was peeled off to obtain a sheet of the electrode layer unit.

Similarly, using solid electrolyte sheets-01 having different thicknesses, sheets of a plurality of electrode layer units having different thicknesses of the solid electrolyte layers were obtained.

### Manufacture of Outermost Layer of Lower Surface Unit

A current collector layer having the thickness of 5 µm was printed and formed on the outermost layer sheet-01, and dried at 80° C. for 10 minutes. Further, an active material layer having the thickness of 5 to 10 µm was printed and formed again thereon and dried at 80° C. for 10 minutes, and thereby an electrode layer which the active material layer exists on only one side of the outermost layer-01. Next, a margin layer having a height substantially equal to that of the electrode layer was formed on the outer periphery of one end of the electrode layer by screen printing, and dried at 80° C. for 10 minutes. Next, the PET film which was the outermost layer-01 was peeled off to obtain a sheet of the outermost layer of lower surface unit.

### Manufacture of Outermost Layer of Upper Surface Unit

An active material layer having the thickness of 5 to 10 µm was printed and formed on a current collector layer sheet-01 having the thickness of 8 µm, and dried at 80° C. for 10 minutes. Further, a current collector layer having a thickness of 5 µm was printed and formed thereon, and dried at 80° C. for 10 minutes, and thereby an electrode layer which the active material layer exists on only one side of the solid electrolyte layer sheet-01. Next, the outermost layer sheet-01 was laminated on the electrode layer, and the PET film of the solid electrolyte layer sheet-01 and the outermost layer sheet-01 were peeled off to obtain an outermost layer sheet-01.

### Manufacture of Laminate

Using the plurality of electrode units, 50 layers were laminated alternatively while being offset with one end of the positive electrode layer and one end of the negative electrode layer shifted from each other. Further, one layer of the outermost layer of lower surface unit and one layer of the outermost layer of bottom surface were laminated on both principle surfaces of the laminate in the lamination direction while being offset in the same manner as the electrode layer unit. Further, the outermost layers were formed by laminating four solid electrolyte sheets on the outermost layer of bottom surface unit and five solid electrolyte sheets on the outermost layer of upper surface unit as the outermost solid electrolyte layer. Next, not calcined laminate of the lithium ion solid electrolyte battery was made by cutting the laminated substrate after it was thermocompression-bonded by a die press. Next, the laminate was heated at heating rate 200° C./h and held at 750° C. for two hours in a nitrogen atmosphere and was taken out after natural cooling for debinding and calcing.

### Outer Electrode Forming Process

An external electrode paste was applied so as to cover both end surfaces and the positive electrodes and the negative electrodes which are exposed on both side surfaces of the obtained laminate of the lithium ion secondary battery, was held at 150° C. for 30 minutes to be thermally cured to form a pair of outer electrodes.

A cell in which a pair of outer electrodes were formed on a laminate of the lithium ion secondary battery was used as an evaluation cell in Example 1.

### Evaluation of Thickness of Solid Electrolyte Layer

A thickness of the solid electrolyte layer of the lithium ion secondary battery in Example 1 was measured using a scanning electron microscope (SEM). In the cross section of the lithium ion secondary battery, the thickness of each layer was measured at 5 points with respect to the 49 solid electrolyte layers in the 50 layers of the laminate excluding the outer solid the outermost solid electrolyte layer, and the average value was taken as the thickness of the solid electrolyte layer.

The thickness t1 which is the thickness of the thickest solid electrolyte layer of the lithium ion secondary battery, the thickness t2 which is the thickness of the thinnest solid electrolyte layer of the lithium ion secondary battery in Example 1 were 10.70 µm, 5.98 µm,respectively. The ratio tl/t2 was 1.79. Further, as a result of calculating the average value of each of the 49 solid electrolyte layers as the average thickness of the solid electrolyte layer, T=8.67 µm.

Based on the thickness of each solid electrolyte layer obtained, the standard deviation σ of the solid electrolyte layer in the lithium ion secondary battery produced in Example 1 was calculated and found to be σ=1.02 µm.

### Examples 2 to 9 and Comparative Examples 1 to 4

Evaluation cells were obtained in the same manner as in Example 1 except that the value t1, t2, and T were changed by changing the electrode units.

### Example 10

### Manufacture of Solid Electrolyte Layer Paste-02

As the solid electrolyte, a solid electrolyte powder-02, which was made as below, was used. The way to make it is that, using Li₂CO₃, Al₂O₃, GeO₂, and NH₄H₂PO₄ as starting materials, the starting materials were dispersed in pure water, and then wet-mixing was performed with a ball mill for 12 hours. After mixing, the powder obtained after dehydration drying was temporarily calcined at 800° C. for two hours in the atmosphere. After temporarily calcined, it was dispersed in pure water, and then wet pulverized with a ball mill for 8 hours. After pulverization, it was dehydrated and dried to obtain solid electrolyte powder-02.

As a result of analysis for the obtained solid electrolyte powder-02 with X-ray diffractometer, it was ascertained that it was lithium aluminum phosphate having a crystal structure corresponding that of NASICON type LiGe₂ (P04)₃.

Next, 100 parts of ethanol and 200 parts of toluene as solvents were added to 100 parts of the solid electrolyte powder-02, and this was wet-mixed with a ball mill. Thereafter, 16 parts of a polyvinyl butyral-based binder and 4.8 parts of benzyl butyl phthalate were added and wet-mixed with a ball mill to obtain a solid electrolyte layer paste-02.

### Manufacture of Solid Electrolyte Layer Sheet-02

Using the obtained solid electrolyte paste-02, a sheet was formed using a PET film as a base by a doctor blade method to obtain a solid electrolyte layer B. In this case, by adjusting the thickness in the range of 5 to 15 µm, a plurality of solid electrolyte sheets-02 having different thicknesses were prepared.

### Manufacture of Outermost Layer Sheet-02

A sheet of the outermost layer was made using a PET film as a base material and using a manufactured solid electrolyte layer paste-02 by doctor blade method to form a sheet having a thickness of 30 µm and an outermost layer sheet-02 was obtained.

### Manufacture of Margin Layer Paste-02

Next, 100 parts of ethanol and 100 parts of toluene as solvents were added to 100 parts of the solid electrolyte powder-02, and this was wet-mixed with a ball mill. Thereafter, 16 parts of a polyvinyl butyral-based binder and 4.8 parts of benzyl butyl phthalate were added and wet-mixed with a ball mill to obtain a margin layer paste-02.

### Example 10

Evaluation cell of Example 10 was obtained in the same manner as in Example 1 except that the solid electrolyte layer sheet-02, the outermost layer sheet-02, the margin layer sheet-02 were used.

### Examples 11 to 18 and Comparative Examples 5 to 8

Evaluation cells of Examples 11 to 18 and Comparative Examples 5 to 8 were obtained in the same manner as in Example 10 except that the value t1, t2, and T were changed by changing the electrode units.

### Evaluation of Output Characteristics

The output characteristics of the evaluation cells produced in Examples and the Comparative Examples were evaluated by charging and discharging under the charging/discharging conditions shown below. For the notation of charging/discharging current, the C (sea) rate notation will be used hereafter. The C rate is express as nC(µA) (n is a numerical value) and means a current capable of charging/discharging a nominal capacitance (µAh) at 1/n(h). For example, 1C means a charging/discharging current that can charge a nominal capacity in 1 h, and 2C means a charging/discharging current that can charge a nominal capacity in 0.5 h. For example, in the case of a lithium ion secondary battery having a nominal capacity of 100 uAh, the current of 0.1 C was 10 uA (calculation formula 100 µA×0.1=10 µA). Similarly, the current of 0.2 C was 20 µA, and the current of 1C was 100 µA.

The evaluation conditions for the output characteristics were as follows. Under thermally neutral environment, constant current charge (CC charge) was performed at a constant current of 0.2 C rate until the battery voltage reaches 1.6 V, and then constant voltage charge (CV charge) was performed up to a current value of 0.05 C rate. After charging, after a pause of 5 minutes, the battery was discharged at a constant current of 0.2 C rate until the battery voltage reached 0 V (CC discharge). The obtained discharge capacity was referred as 0.2 C discharge capacity.

After that, under thermally neutral environment, constant current charge (CC charge) was performed until the battery voltage reached 1.6 V at a constant current of 0.2 C rate, and then constant voltage charge (CV charge) was performed until the current value of 0.05 C rate was reached. After a 5-minute pause after charging, the battery was discharged at a constant current of 1.0 C rate until the battery voltage reached 0 V (CC discharge). The obtained discharge capacity was referred as 1.0 C discharge capacity.

The ratio of the 1.0 C discharge capacity to the 0.2 C discharge capacity was calculated by the following formula (1) as the output characteristic in this embodiment.

$$\begin{matrix}\text{Output characteristics} \left(\%\right) = \\ \left(1.0 \text{C} \text{discharge capacity/0} \text{.2C discharge capacity}\right) \times 100 \\ \end{matrix}$$

The value t1, t2, and T, the obtained standard deviation σ of the solid electrolyte layers, and the evaluation result of output characteristics in Examples 1 to 18 and Comparative Examples 1 to 8 were shown in Table 1.

TABLE 1

| | average electrolyte thickness | t1 | t2 | tl/t2 | standard deviation σ(µm) | rate characteristics | rate characteristics improvement rate |
|---|---|---|---|---|---|---|---|
| | µm | µm | µm | | | %(1.0C/0.2C) | %(Example/ Comparative Example) |
| Example 1 | 8.67 | 10.7 | 5.98 | 1.79 | 1.02 | 81 | 150.0 |
| Example 2 | 8.69 | 10.9 | 5.47 | 1.99 | 0.91 | 79 | 146.3 |
| Example 3 | 8.66 | 9.91 | 6.47 | 1.53 | 1.03 | 81 | 150.0 |
| Example 4 | 8.75 | 9.67 | 6.99 | 1.38 | 0.76 | 78 | 144.4 |
| Example 5 | 8.68 | 8.99 | 6.71 | 1.34 | 0.81 | 82 | 151.9 |
| Example 6 | 8.55 | 8.81 | 7.29 | 1.21 | 0.66 | 80 | 148.1 |
| Example 7 | 8.66 | 9.11 | 8.22 | 1.11 | 0.33 | 76 | 140.7 |
| Example 8 | 8.67 | 8.95 | 8.47 | 1.06 | 0.25 | 76 | 140.7 |
| Example 9 | 8.81 | 8.87 | 8.73 | 1.02 | 0.08 | 74 | 137.0 |
| Comparative Example 1 | 8.51 | 8.55 | 8.5 | 1.01 | 0.03 | 54 | 100.0 |
| Comparative Example 2 | 8.59 | 8.59 | 8.6 | 1.00 | 0.005 | 55 | - |
| Comparative Example 3 | 8.24 | 9.91 | 4.96 | 2.00 | 1.05 | 57 | - |
| Comparative Example 4 | 8.03 | 10.1 | 4.88 | 2.07 | 10.3 | 52 | - |
| Example 10 | 8.65 | 10.6 | 5.99 | 1.77 | 10.30 | 83 | 148.2 |
| Example 11 | 8.68 | 10.8 | 5.45 | 1.98 | 0.92 | 80 | 142.9 |
| Example 12 | 8.66 | 9.89 | 6.48 | 1.53 | 1.03 | 82 | 146.4 |
| Example 13 | 8.77 | 9.7 | 7.01 | 1.38 | 0.78 | 83 | 148.2 |
| Example 14 | 8.59 | 8.97 | 6.67 | 1.34 | 0.8 | 85 | 151.8 |
| Example 15 | 8.55 | 8.91 | 7.32 | 1.22 | 0.68 | 82 | 146.4 |
| Example 16 | 8.61 | 9.19 | 8.25 | 1.11 | 0.31 | 79 | 141.1 |
| Example 17 | 8.62 | 8.93 | 8.37 | 1.07 | 0.21 | 80 | 142.9 |
| Example 18 | 8.81 | 8.87 | 8.65 | 1.03 | 0.09 | 77 | 137.5 |
| Comparative Example 5 | 8.61 | 8.61 | 8.6 | 1.00 | 0.02 | 56 | 100.0 |
| Comparative Example 6 | 8.47 | 8.46 | 8.47 | 1.00 | 0.008 | 56 | - |
| Comparative Example 7 | 8.33 | 9.81 | 4.87 | 2.01 | 1.04 | 53 | - |
| Comparative Example 8 | 7.82 | 10.3 | 5.08 | 2.03 | 10.1 | 54 | - |

From the result of Examples 1 to 9 and Comparative Examples 1 to 4, superior output characteristics can be obtained in the range where the ratio tl/t2 of the average thickness t1 of the thickest solid electrolyte layer to the average thickness t2 of the thinnest solid electrolyte is 1.02<tl/t2<1.99.

### Examples 19 to 26

Evaluation cells of Examples 19 to 26 were obtained in the same manner as in Example 1 except that the electrode layer unit was changed and the standard deviation σ of the average thickness of the solid electrolyte layer was changed when the laminate was manufactured, and were evaluated in the same manner as in Example 1. The evaluation results were shown in Table 2.

### Examples 27 to 34

Evaluation cells of Examples 27 to 34 were obtained in the same manner as in Example 10 except that the electrode layer unit was changed and the standard deviation σ of the average thickness of the solid electrolyte layer was changed when the laminate was manufactured, and were evaluated in the same manner as in Example 1. The evaluation results were shown in Table 2.

TABLE 2

| | average electrolyte thickness | t1 | t2 | tl/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Comparative Example) |
| Example 19 | 8.43 | 9.91 | 6.42 | 1.54 | 0.33 | 80 | 148.1 |
| Example 20 | 8.51 | 9.87 | 6.53 | 1.51 | 0.55 | 82 | 151.9 |
| Example 21 | 8.39 | 9.77 | 6.44 | 1.52 | 0.81 | 83 | 153.7 |
| Example 22 | 8.43 | 9.85 | 6.51 | 1.51 | 1.24 | 83 | 153.7 |
| Example 23 | 8.37 | 9.92 | 6.55 | 1.51 | 1.52 | 79 | 146.3 |
| Example 24 | 8.55 | 9.97 | 6.48 | 1.54 | 1.66 | 78 | 144.4 |
| Example 25 | 8.29 | 9.89 | 6.55 | 1.51 | 1.67 | 72 | 133.3 |
| Example 26 | 8.30 | 9.86 | 6.55 | 1.51 | 1.99 | 73 | 135.2 |
| Example 12 | 8.66 | 9.89 | 6.48 | 1.53 | 1.03 | 82 | 146.4 |
| Example 27 | 8.43 | 9.91 | 6.42 | 1.54 | 0.33 | 82 | 146.4 |
| Example 28 | 8.51 | 9.87 | 6.53 | 1.51 | 0.55 | 84 | 150.0 |
| Example 29 | 8.39 | 9.77 | 6.44 | 1.52 | 0.81 | 83 | 148.2 |
| Example 30 | 8.43 | 9.85 | 6.51 | 1.51 | 1.24 | 83 | 148.2 |
| Example 31 | 8.37 | 9.92 | 6.55 | 1.51 | 1.52 | 82 | 146.4 |
| Example 32 | 8.55 | 9.97 | 6.48 | 1.54 | 1.66 | 80 | 142.9 |
| Example 33 | 8.29 | 9.89 | 6.55 | 1.51 | 1.67 | 74 | 132.1 |
| Example 34 | 8.30 | 9.86 | 6.55 | 1.51 | 1.99 | 76 | 135.7 |

From the result of Examples 19 to 34, superior output characteristics can be obtained in the range where the standard deviation σ of the average thickness of solid electrolyte layer satisfies 0.15<σ<1.66 µm.

### Example 35

### Manufacture of Intermediate Layer Paste

As a base material for the intermediate layer, the lithium vanadium phosphate powder which is manufactured in Example 1 and titanium phosphate aluminum lithium powder were wet-mixed with a ball mill for 16 hours, and then the mixed powder was dehydrated and dried. After drying, the obtained powder was temporarily calcined at 850° C. for two hours in a nitrogen-hydrogen mixed gas. After temporarily calcined, it was wet pulverized with a ball mill, and dehydrated and dried to obtain lithium vanadium phosphate as an active substance powder.

An intermediate layer paste was made by adding 15 parts of ethyl cellulose as a binder and 65 parts of dihydroterpineol as a solvent to 100 parts of powders of the intermediate layer powder obtained together, and mixing and dispersing them.

The electrode layer unit was obtained in the same manner as in Example 3 except that the intermediate layer paste was applied on the solid electrolyte layer sheet and the intermediate layer having a thickness of 2 µm was formed.

### Example 36

The electrode layer unit was obtained in the same manner as in Example 35 except that titanium oxide (TiCO₂) was used as a base material for the intermediate layer.

### Example 37

The electrode layer unit was obtained in the same manner as in Example 35 except that aluminum oxide (AI₂O₃) was used as a base material for the intermediate layer.

### Example 38

The electrode layer unit was obtained in the same manner as in Example 35 except that zirconium oxide (ZrO₂) was used as a base material for the intermediate layer.

### Example 39

The electrode layer unit was obtained in the same manner as in Example 12 except that zirconium oxide (ZrO₂) was used as a base material for the intermediate layer.

The cross section of the obtained electrode layer units were observed using a scanning electron microscope energy dispersive X-ray spectroscope (SEM-EDS), and the constituent elements contained in the intermediate layers were analyzed.

Evaluation cells of Examples 35 to 39 were obtained in the same manner as in Example 3, and were evaluated in the same manner as in Example 1. The evaluation results were shown in Table 3.

TABLE 3

| | average electrolyte thickness | t1 | t2 | tl/t2 | standard deviation σ(µm) | intermediate layer | constituent elements | rate characteristics | rate characteristics improvement rate |
|---|---|---|---|---|---|---|---|---|---|
| | µm | µm | µm | | | | | %(1.0 C/0.2 C) | %(Example/ Comparative Example) |
| Example 35 | 8.59 | 9.77 | 6.51 | 1.50 | 1.01 | comprised | Li,Al,Ti,V,P,O | 85 | 151.8 |
| Example 36 | 8.71 | 9.80 | 6.56 | 1.49 | 0.98 | comprised | Ti,O | 84 | 150.0 |
| Example 37 | 8.69 | 9.92 | 6.45 | 1.54 | 1.05 | comprised | Al,O | 85 | 151.8 |
| Example 38 | 8.55 | 9.84 | 6.43 | 1.53 | 1.04 | comprised | Zr,O | 79 | 141.1 |
| Example 39 | 8.55 | 9.84 | 6.43 | 1.53 | 1.04 | comprised | Zr,O | 79 | 141.1 |

From the results of Examples 35 to 38, superior output characteristics can be obtained by comprising the intermediate layer between the solid electrolyte layer and the electrode layer. Further, by comparing the results of Example 38 and 39, it was confirmed that the output characteristics were improved not by the composition of the intermediate layer but by the elements constituting the intermediate layer.

### Example 40

In the preparation of a paste for an active material, a positive electrode active material layer paste was manufactured using lithium iron phosphate (LiFePO₄) as an active material powder, and a negative electrode active material layer paste was manufactured using lithium titanate (Li₄Ti₅Oₗ₂) as an active material powder.

Electrode layer unit was obtained in the same manner as in Example 1 except that the above obtained positive electrode active material layer paste and the above obtained negative electrode active material layer paste were used. Hereinafter, the electrode unit manufactured by using the positive electrode active material layer paste is referred as the positive electrode layer unit, the electrode unit manufactured by using the negative electrode active material layer paste is referred as the negative electrode layer unit.

Evaluation cell of Example 40 was obtained in the same manner as in Example 1 except that using a plurality of the positive electrode layer units and a plurality of the negative electrode layer units, the positive electrode layer and of the negative electrode layer were laminated alternatively while being offset with each one ends of them shifted from each other in the manufacturing a laminate.

### Examples 41 to 48 and Comparative Examples 9 to 12

Evaluation cells of Examples 41 to 48 and Comparative Examples 9 to 12 were obtained in the same manner as in Example 39 except that the standard deviation σ of the average thickness of the solid electrolyte layer was changed by changing the positive electrode layer unit and the negative electrode layer unit when the laminate was manufactured.

### Evaluation of Output Characteristics

The evaluation conditions for the output characteristics were as follows. Under thermally neutral environment, constant current charge (CC charge) was performed at a constant current of 0.2 C rate until the battery voltage reaches 3.0 V, and then constant voltage charge (CV charge) was performed up to a current value of 0.05 C rate. After charging, after a pause of 5 minutes, the battery was discharged at a constant current of 0.2 C rate until the battery voltage reached 1.5 V (CC discharge). The obtained discharge capacity was referred as 0.2 C discharge capacity.

After that, under thermally neutral environment, constant current charge (CC charge) was performed until the battery voltage reached 3.0 V at a constant current of 0.2 C rate, and then constant voltage charge (CV charge) was performed until the current value of 0.05 C rate was reached. After a 5-minute pause after charging, the battery was discharged at a constant current of 1.0 C rate until the battery voltage reached 1.5 V (CC discharge). The obtained discharge capacity was referred as 1.0 C discharge capacity.

The ratio of the 1.0 C discharge capacity to the 0.2 C discharge capacity was calculated by the following formula (2) as the output characteristic in this embodiment.

$$\begin{matrix}\text{Output characteristics} \left(\%\right) = \left(1.0 \text{C discharge capacity/0} \text{.2C discharge capacity}\right) \\ \times 100\end{matrix}$$

The value t1, t2, and T, the obtained standard deviation σ of the solid electrolyte layers, and the evaluation result of output characteristics in Examples 40 to 48 and Comparative Examples 9 to 12 were shown in Table 4.

TABLE 4

| | average electrolyte thickness | t1 | t2 | tl/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Comparative Example) |
| Example 40 | 8.65 | 10.6 | 5.99 | 1.77 | 1.03 | 75 | 144.2 |
| Example 41 | 8.68 | 10.8 | 5.45 | 1.98 | 0.92 | 72 | 138.5 |
| Example 42 | 8.66 | 9.89 | 6.48 | 1.53 | 1.03 | 73 | 140.4 |
| Example 43 | 8.77 | 9.7 | 7.01 | 1.38 | 0.78 | 74 | 142.3 |
| Example 44 | 8.59 | 8.97 | 6.67 | 1.34 | 0.8 | 77 | 148.1 |
| Example 45 | 8.55 | 8.91 | 7.32 | 1.22 | 0.68 | 74 | 142.3 |
| Example 46 | 8.61 | 9.19 | 8.25 | 1.11 | 0.31 | 71 | 136.5 |
| Example 47 | 8.62 | 8.93 | 8.37 | 1.07 | 0.21 | 70 | 134.6 |
| Example 48 | 8.81 | 8.87 | 8.65 | 1.03 | 0.09 | 65 | 125.0 |
| Comparative Example 9 | 8.61 | 8.61 | 8.6 | 1.00 | 0.02 | 52 | 100.0 |
| Comparative Example 10 | 8.47 | 8.46 | 8.47 | 1.00 | 0.008 | 51 | - |
| Comparative Example 11 | 8.33 | 9.81 | 4.87 | 2.01 | 1.04 | 50 | - |
| Comparative Example 12 | 7.82 | 10.3 | 5.08 | 2.03 | 10.1 | 54 | - |

From the result of Examples 40 to 48 and Comparative Examples 9 to 12, superior output characteristics can be obtained in the range where the ratio tl/t2 of the average thickness t1 of the thickest solid electrolyte layer to the average thickness t2 of the thinnest solid electrolyte satisfies 1.02<tl/t2<1.99.

### Example 49

### Manufacture of Solid Electrolyte Layer Paste-03

As the solid electrolyte, the solid electrolyte powder-03 manufactured by following method was used. The manufacturing method is that, first, Li₂CO₃ and SiO₂ were mixed, and calcined at 800° C. to obtain precursor. The obtained precursor and Li₃PO₄ were mixed and pressed at 34.5 MPa and calcined at 1000° C. After that, impurities on the surface were removed by heat treatment at 400° C. After heat treatment, it was wet-mixed with a ball mill for 8 hours to obtain solid electrolyte-03.

As a result of analysis for the obtained solid electrolyte powder-03 with X-ray diffractometer, it was ascertained that it was a compound having a crystal structure corresponding that of Li₃.₆Siₒ.₆Pₒ.₄O₄.

Next, 100 parts of ethanol and 200 parts of toluene as solvents were added to 100 parts of the solid electrolyte powder-03, and this was wet-mixed with a ball mill. Thereafter, 16 parts of a polyvinyl butyral-based binder and 4.8 parts of benzyl butyl phthalate were added and wet-mixed with a ball mill to obtain a solid electrolyte layer paste-03.

### Manufacture of Solid Electrolyte Layer Sheet-03

Using the obtained solid electrolyte paste-03, a sheet was formed using a PET film as a base by a doctor blade method to obtain a solid electrolyte layer. In this case, by adjusting the thickness in the range of 5 to 15 µm, a plurality of solid electrolyte sheets-03 having different thicknesses were prepared.

### Manufacture of Outermost Layer Sheet-03

A sheet of the outermost layer was made using a PET film as a base material and using a manufactured solid electrolyte layer paste-03 by doctor blade method to form a sheet having a thickness of 30 µm and an outermost layer sheet-03 was obtained.

### Manufacture of Margin Layer Paste-03

Next, 100 parts of ethanol and 100 parts of toluene as solvents were added to 100 parts of the solid electrolyte powder-03, and this was wet-mixed with a ball mill. Thereafter, 16 parts of a polyvinyl butyral-based binder and 4.8 parts of benzyl butyl phthalate were added and wet-mixed with a ball mill to obtain a margin layer paste-03.

Evaluation cell of Example 49 was obtained in the same manner as Example 40 except that the solid electrolyte layer sheet-03, the outermost layer sheet-03, and the margin layer sheet-03 were used.

### Examples 50 to 57 and Comparative Examples 13 to 16

Examples 50 to 57 and Comparative Examples 13 to 16 were obtained in the same manner as in Example 49 except that the standard deviation σ of the average thickness of the solid electrolyte layer was changed by changing the positive electrode layer unit and the negative electrode layer unit when the laminate was manufactured.

### Evaluation of Output Characteristics

The value t1, t2, and T, the obtained standard deviation σ of the solid electrolyte layers, and the evaluation result of output characteristics in Examples 49 to 57 and Comparative Examples 13 to 16 were shown in Table 5. It is noted that the evaluation of output characteristics was performed in the same conditions as the conditions in Example 40.

TABLE 5

| | average electrolyte thickness | t1 | t2 | tl/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Comparative Example) |
| Example 49 | 8.75 | 10.7 | 5.99 | 1.79 | 1.02 | 79 | 143.6 |
| Example 50 | 8.79 | 10.9 | 5.49 | 1.99 | 0.94 | 74 | 134.5 |
| Example 51 | 8.77 | 9.88 | 6.52 | 1.52 | 1.01 | 74 | 134.5 |
| Example 52 | 8.81 | 9.73 | 7.01 | 1.39 | 0.81 | 75 | 136.4 |
| Example 53 | 8.55 | 8.97 | 6.87 | 1.31 | 0.80 | 78 | 141.8 |
| Example 54 | 8.51 | 8.91 | 7.35 | 1.21 | 0.66 | 75 | 136.4 |
| Example 55 | 8.72 | 9.22 | 8.25 | 1.12 | 0.29 | 71 | 129.1 |
| Example 56 | 8.72 | 9.00 | 8.33 | 1.08 | 0.21 | 69 | 125.5 |
| Example 57 | 8.89 | 8.88 | 8.64 | 1.03 | 0.08 | 64 | 116.4 |
| Comparative Example 13 | 8.72 | 8.61 | 8.6 | 1.00 | 0.18 | 55 | 100.0 |
| Comparative Example 14 | 8.52 | 8.46 | 8.47 | 1.00 | 0.008 | 52 | - |
| Comparative Example 15 | 8.38 | 9.81 | 4.87 | 2.01 | 1.03 | 49 | - |
| Comparative Example 16 | 7.91 | 10.3 | 5.08 | 2.03 | 9.98 | 54 | - |

### Example 58

### Manufacture of Solid Electrolyte Layer Paste-04

As the solid electrolyte, a solid electrolyte powder-04, which was made as below, was used. The way to make it is that, using LiCO₃, La(OH)₃, and ZrO₂ as starting materials, the starting materials were dispersed in ethanol, and then wet-mixing was performed with a ball mill for 12 hours. After mixing, the powder obtained after drying was heat treated at 900° C. for five hours. After heat treated, it was wet pulverized with a ball mill for 12 hours. After pulverization, it was dehydrated and dried to obtain solid electrolyte powder-04.

As a result of analysis for the obtained solid electrolyte powder-04 with X-ray diffractometer, it was ascertained that it was a compound having a crystal structure corresponding that of Li₇La₃Zr₂O₁₂.

Next, 100 parts of ethanol and 200 parts of toluene as solvents were added to 100 parts of the solid electrolyte powder-04, and this was wet-mixed with a ball mill. Thereafter, 16 parts of a polyvinyl butyral-based binder and 4.8 parts of benzyl butyl phthalate were added and wet-mixed with a ball mill to obtain a solid electrolyte layer paste-04.

### Manufacture of Solid Electrolyte Layer Sheet-04

Using the obtained solid electrolyte paste-04, a sheet was formed using a PET film as a base by a doctor blade method to obtain a solid electrolyte layer. In this case, by adjusting the thickness in the range of 5 to 15 µm, a plurality of solid electrolyte sheets-04 having different thicknesses were prepared.

### Manufacture of Outermost Layer Sheet-04

A sheet of the outermost layer was made using a PET film as a base material and using a manufactured solid electrolyte layer paste-04 by doctor blade method to form a sheet having a thickness of 30 µm and an outermost layer sheet-04 was obtained

### Manufacture of Margin Layer Paste-04

Next, 100 parts of ethanol and 100 parts of toluene as solvents were added to 100 parts of the solid electrolyte powder-04, and this was wet-mixed with a ball mill. Thereafter, 16 parts of a polyvinyl butyral-based binder and 4.8 parts of benzyl butyl phthalate were added and wet-mixed with a ball mill to obtain a margin layer paste-04.

Evaluation cell of Example 58 was obtained in the same manner as in Example 40 except that the solid electrolyte layersheet-04, the outermost layer sheet-04, the margin layer sheet-04 were used.

### Examples 59 to 66 and Comparative Examples 17 to 20

Examples 59 to 66 and Comparative Examples 17 to 20 were obtained in the same manner as in Example 58 except that the standard deviation σ of the average thickness of the solid electrolyte layer was changed by changing the positive electrode layer unit and the negative electrode layer unit when the laminate was manufactured.

### Evaluation of Output Characteristics

The value t1, t2, and T, the obtained standard deviation σ of the solid electrolyte layers, and the evaluation result of output characteristics in Examples 58 to 66 and Comparative Examples 17 to 20 were shown in Table 6. It is noted that the evaluation of output characteristics was performed in the same conditions as the conditions in Example 40.

TABLE 6

| | average electrolyte thickness | t1 | t2 | t1/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Comparative Example) |
| Example 58 | 8.65 | 10.9 | 5.99 | 1.82 | 1.03 | 73 | 130.4 |
| Example 59 | 8.68 | 11.0 | 5.54 | 1.99 | 0.92 | 70 | 125.0 |
| Example 60 | 8.66 | 9.77 | 6.51 | 1.50 | 1.03 | 71 | 126.8 |
| Example 61 | 8.77 | 9.66 | 7.08 | 1.36 | 0.78 | 72 | 128.6 |
| Example 62 | 8.59 | 8.89 | 6.59 | 1.35 | 0.8 | 76 | 135.7 |
| Example 63 | 8.55 | 8.92 | 7.35 | 1.21 | 0.68 | 71 | 126.8 |
| Example 64 | 8.61 | 9.21 | 8.19 | 1.12 | 0.31 | 68 | 121.4 |
| Example 65 | 8.62 | 8.97 | 8.41 | 1.07 | 0.21 | 68 | 121.4 |
| Example 66 | 8.81 | 8.86 | 8.63 | 1.03 | 0.09 | 62 | 110.7 |
| Comparative Example 17 | 8.61 | 8.59 | 8.65 | 0.99 | 0.02 | 56 | 100.0 |
| Comparative Example 18 | 8.47 | 8.64 | 8.55 | 1.01 | 0.008 | 51 | - |
| Comparative Example 19 | 8.33 | 9.91 | 4.91 | 2.02 | 1.04 | 52 | - |
| Comparative Example 20 | 7.82 | 10.6 | 5.27 | 2.01 | 10.1 | 55 | - |

### Example 67

### Manufacture of Solid Electrolyte Paste-05

As the solid electrolyte, a solid electrolyte powder-05, which was made as below, was used. The way to make it is that, first, using LiCO₃, La₂O₃, and TiO₂ as starting materials, the starting materials were dry-mixed with an agate mortar. After mixing, the obtained powder was heat treated at 1100° C. for 12 hours and sintered at 1250° C. for five hours. After sintering, it was quenched to room temperature, and then dry pulverized with a ball mill for 12 hours to obtain solid electrolyte powder-05.

As a result of analysis for the obtained solid electrolyte powder-05 with X-ray diffractometer, it was ascertained that it was a compound having a crystal structure corresponding that of Li_{0.56}Li_{0.31}TiO₃.

Next, 100 parts of ethanol and 200 parts of toluene as solvents were added to 100 parts of the solid electrolyte powder-05, and this was wet-mixed with a ball mill. Thereafter, 16 parts of a polyvinyl butyral-based binder and 4.8 parts of benzyl butyl phthalate were added and wet-mixed with a ball mill to obtain a solid electrolyte layer paste-05.

### Manufacture of Solid Electrolyte Layer Sheet-05

Using the obtained solid electrolyte paste-05, a sheet was formed using a PET film as a base by a doctor blade method to obtain a solid electrolyte layer. In this case, by adjusting the thickness in the range of 5 to 15 µm, a plurality of solid electrolyte sheets-05 having different thicknesses were prepared.

### Manufacture of Outermost Layer Sheet-05

A sheet of the outermost layer was made using a PET film as a base material and using a manufactured solid electrolyte layer paste-05 by doctor blade method to form a sheet having a thickness of 30 µm and an outermost layer sheet-05 was obtained.

### Manufacture of Margin Layer Paste-05

Next, 100 parts of ethanol and 100 parts of toluene as solvents were added to 100 parts of the solid electrolyte powder-05, and this was wet-mixed with a ball mill. Thereafter, 16 parts of a polyvinyl butyral-based binder and 4.8 parts of benzyl butyl phthalate were added and wet-mixed with a ball mill to obtain a margin layer paste-05.

In the preparation of a paste for an active material, a positive electrode active material layer paste and negative electrode active material were manufactured using lithium iron manganate (LiMn₂O₄) as an active material powder.

Evaluation cell of Example 67 was obtained in the same manner as Example 40 except that the solid electrolyte layer sheet-05, the outermost layer sheet-05, and the margin layer sheet-05 were used.

### Examples 68 to 75 and Comparative Examples 21 to 24

Examples 68 to 75 and Comparative Examples 21 to 24 were obtained in the same manner as in Example 67 except that the standard deviation σ of the average thickness of the solid electrolyte layer was changed by changing the positive electrode layer unit and the negative electrode layer unit when the laminate was manufactured.

### Evaluation of Output Characteristics

The evaluation conditions for the output characteristics were as follows. Under thermally neutral environment, constant current charge (CC charge) was performed at a constant current of 0.2 C rate until the battery voltage reaches 2.0 V, and then constant voltage charge (CV charge) was performed up to a current value of 0.05 C rate. After charging, after a pause of 5 minutes, the battery was discharged at a constant current of 0.2 C rate until the battery voltage reached 0.5 V (CC discharge). The obtained discharge capacity was referred as 0.2 C discharge capacity.

After that, under thermally neutral environment, constant current charge (CC charge) was performed until the battery voltage reached 2.0 V at a constant current of 0.2 C rate, and then constant voltage charge (CV charge) was performed until the current value of 0.05 C rate was reached. After a 5-minute pause after charging, the battery was discharged at a constant current of 1.0 C rate until the battery voltage reached 1.5 V (CC discharge). The obtained discharge capacity was referred as 1.0 C discharge capacity.

The ratio of the 1.0 C discharge capacity to the 0.2C discharge capacity was calculated by the following formula (3) as the output characteristic in this embodiment.

$$\begin{matrix}\text{Output characteristics} \left(\%\right) = \left(1.0 \text{C discharge capacity/0} \text{.2C discharge capacity}\right) \\ \times 100\end{matrix}$$

The value t1, t2, and T, the obtained standard deviation σ of the solid electrolyte layers, and the evaluation result of output characteristics in Examples 67 to 68 and Comparative Examples 21 to 24 were shown in Table 7.

TABLE 7

| | average electrolyte thickness | t1 | t2 | t1/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Comparative Example) |
| Example 67 | 8.65 | 10.8 | 6.06 | 1.78 | 1.03 | 63 | 128.6 |
| Example 68 | 8.68 | 10.9 | 5.48 | 1.99 | 0.92 | 60 | 122.4 |
| Example 69 | 8.66 | 9.92 | 6.55 | 1.51 | 1.03 | 61 | 124.5 |
| Example 70 | 8.77 | 9.56 | 6.99 | 1.37 | 0.78 | 63 | 128.6 |
| Example 71 | 8.59 | 8.97 | 6.81 | 1.32 | 0.8 | 62 | 126.5 |
| Example 72 | 8.55 | 9.02 | 7.45 | 1.21 | 0.68 | 60 | 122.4 |
| Example 73 | 8.61 | 9.36 | 8.22 | 1.14 | 0.31 | 57 | 116.3 |
| Example 74 | 8.62 | 8.93 | 8.44 | 1.06 | 0.21 | 58 | 118.4 |
| Example 75 | 8.81 | 8.91 | 8.73 | 1.02 | 0.09 | 57 | 116.3 |
| Comparative Example 21 | 8.61 | 8.55 | 8.54 | 1.00 | 0.02 | 49 | 100.0 |
| Comparative Example 22 | 8.47 | 8.58 | 8.46 | 1.01 | 0.008 | 47 | - |
| Comparative Example 23 | 8.33 | 9.91 | 4.93 | 2.01 | 1.04 | 47 | - |
| Comparative Example 24 | 7.82 | 10.2 | 5.08 | 2.01 | 10.1 | 48 | - |

### Example 76

### Manufacture of Solid Electrolyte Paste-06

As the solid electrolyte, the solid electrolyte powder-06 manufactured by following method was used. The manufacturing method is that, first, LiOH▪H₂O and H₃BO₃ were mixed, and placed in an aluminum crucible and heat-treated at 600° C. for three hours in the atmosphere to obtain precursor A. Next, LiOH ▪H₂O was heat-treated at 300° C. for two hours in the atmosphere to obtain precursor B. The obtained precursor A and precursor B were mixed and being performed mechanical milling with ball mill for 100 hours to obtain solid electrolyte powder-06.

As a result of analysis for the obtained solid electrolyte powder-06 with X-ray diffractometer, it was ascertained that it was a glass ceramic having a crystal structure corresponding that of Li₃BO₃—Li₂SO₄.

Next, 100 parts of ethanol and 200 parts of toluene as solvents were added to 100 parts of the solid electrolyte powder-06, and this was wet-mixed with a ball mill. Thereafter, 16 parts of a polyvinyl butyral-based binder and 4.8 parts of benzyl butyl phthalate were added and wet-mixed with a ball mill to obtain a solid electrolyte layer paste-06.

### Manufacture of Solid Electrolyte Layer Sheet-06

Using the obtained solid electrolyte paste-06, a sheet was formed using a PET film as a base by a doctor blade method to obtain a solid electrolyte layer. In this case, by adjusting the thickness in the range of 5 to 15 µm, a plurality of solid electrolyte sheets-06 having different thicknesses were prepared.

### Manufacture of Outermost Layer Sheet-06

A sheet of the outermost layer was made using a PET film as a base material and using a manufactured solid electrolyte layer paste-06 by doctor blade method to form a sheet having a thickness of 30 µm and an outermost layer sheet-06 was obtained.

### Manufacture of Margin Layer Paste-06

Next, 100 parts of ethanol and 100 parts of toluene as solvents were added to 100 parts of the solid electrolyte powder-06, and this was wet-mixed with a ball mill. Thereafter, 16 parts of a polyvinyl butyral-based binder and 4.8 parts of benzyl butyl phthalate were added and wet-mixed with a ball mill to obtain a margin layer paste-06.

Evaluation cell of Example 76 was obtained in the same manner as Example 40 except that the solid electrolyte layer sheet-06, the outermost layer sheet-06, and the margin layer sheet-06 were used.

### Examples 77 to 84 and Comparative Examples 25 to 28

Examples 77 to 84 and Comparative Examples 25 to 28 were obtained in the same manner as in Example 67 except that the standard deviation σ of the average thickness of the solid electrolyte layer was changed by changing the positive electrode layer unit and the negative electrode layer unit when the laminate was manufactured.

### Evaluation of Output Characteristics

The value t1, t2, and T, the obtained standard deviation σ of the solid electrolyte layers, and the evaluation result of output characteristics in Examples 76 to 84 and Comparative Examples 25 to 28 were shown in Table 8. It is noted that the evaluation of output characteristics was performed in the same conditions as the conditions in Example 40.

TABLE 8

| | average electrolyte thickness | t1 | t2 | t1/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Comparative Example) |
| Example 76 | 8.65 | 10.6 | 5.99 | 1.77 | 1.04 | 65 | 125.0 |
| Example 77 | 8.68 | 10.8 | 5.45 | 1.98 | 0.89 | 63 | 121.2 |
| Example 78 | 8.66 | 9.89 | 6.48 | 1.53 | 1.01 | 64 | 123.1 |
| Example 79 | 8.77 | 9.7 | 7.01 | 1.38 | 0.83 | 65 | 125.0 |
| Example 80 | 8.59 | 8.97 | 6.67 | 1.34 | 0.76 | 66 | 126.9 |
| Example 81 | 8.55 | 8.91 | 7.32 | 1.22 | 0.66 | 63 | 121.2 |
| Example 82 | 8.61 | 9.19 | 8.25 | 1.11 | 0.39 | 60 | 115.4 |
| Example 83 | 8.62 | 8.93 | 8.37 | 1.07 | 0.18 | 59 | 113.5 |
| Example 84 | 8.81 | 8.87 | 8.65 | 1.03 | 0.11 | 56 | 107.7 |
| Comparative Example 25 | 8.61 | 8.61 | 8.6 | 1.00 | 0.02 | 52 | 100.0 |
| Comparative Example 26 | 8.47 | 8.46 | 8.47 | 1.00 | 0.008 | 50 | - |
| Comparative Example 27 | 8.33 | 9.81 | 4.87 | 2.01 | 1.04 | 50 | - |
| Comparative Example 28 | 7.82 | 10.3 | 5.08 | 2.03 | 10.1 | 52 | - |

### Example 85

### Manufacture of Solid Electrolyte Paste-07

As the solid electrolyte, the solid electrolyte powder-07 manufactured by following method was used. The manufacturing method is that, first, LiOH▪H₂O and H₃BO₃ were mixed, and placed in an aluminum crucible and heat-treated at 600° C. for three hours in the atmosphere to obtain precursor A. Next, LiOH ▪H₂O was heat-treated at 300° C. for two hours in the atmosphere to obtain precursor B. The obtained precursor A, precursor B and Li₂CO₃ were mixed and being performed mechanical milling with ball mill for 100 hours to obtain solid electrolyte powder-07.

As a result of analysis for the obtained solid electrolyte powder-07 with X-ray diffractometer, it was ascertained that it was a glass ceramic having a crystal structure corresponding that of Li₃BO₃—Li₂SO₄—Li₂CO₃.

Next, 100 parts of ethanol and 200 parts of toluene as solvents were added to 100 parts of the solid electrolyte powder-07, and this was wet-mixed with a ball mill. Thereafter, 16 parts of a polyvinyl butyral-based binder and 4.8 parts of benzyl butyl phthalate were added and wet-mixed with a ball mill to obtain a solid electrolyte layer paste-07.

### Manufacture of Solid Electrolyte Layer Sheet-07

Using the obtained solid electrolyte paste-07, a sheet was formed using a PET film as a base by a doctor blade method to obtain a solid electrolyte layer. In this case, by adjusting the thickness in the range of 5 to 15 µm, a plurality of solid electrolyte sheets-07 having different thicknesses were prepared.

### Manufacture of Outermost Layer Sheet-07

A sheet of the outermost layer was made using a PET film as a base material and using a manufactured solid electrolyte layer paste-07 by doctor blade method to form a sheet having a thickness of 30 µm and an outermost layer sheet-07 was obtained.

### Manufacture of Margin Layer Paste-07

Next, 100 parts of ethanol and 100 parts of toluene as solvents were added to 100 parts of the solid electrolyte powder-07, and this was wet-mixed with a ball mill. Thereafter, 16 parts of a polyvinyl butyral-based binder and 4.8 parts of benzyl butyl phthalate were added and wet-mixed with a ball mill to obtain a margin layer paste-07.

Evaluation cell of Example 85 was obtained in the same manner as Example 40 except that the solid electrolyte layer sheet-07, the outermost layer sheet-07, and the margin layer sheet-07 were used.

### Examples 86 to 93 and Comparative Examples 29 to 32

Examples 86 to 93 and Comparative Examples 29 to 32 were obtained in the same manner as in Example 85 except that the standard deviation σ of the average thickness of the solid electrolyte layer was changed by changing the positive electrode layer unit and the negative electrode layer unit when the laminate was manufactured.

### Evaluation of Output Characteristics

The value t1, t2, and T, the obtained standard deviation σ of the solid electrolyte layers, and the evaluation result of output characteristics in Examples 85 to 93 and Comparative Examples 29 to 32 were shown in Table 9. It is noted that the evaluation of output characteristics was performed in the same conditions as the conditions in Example 40.

TABLE 9

| | average electrolyte thickness | t1 | t2 | t1/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Conparative Example) |
| Example 85 | 8.65 | 10.6 | 5.99 | 1.77 | 10.30 | 64 | 125.5 |
| Example 86 | 8.68 | 10.8 | 5.45 | 1.98 | 0.92 | 63 | 123.5 |
| Example 87 | 8.66 | 9.89 | 6.48 | 1.53 | 1.03 | 65 | 127.5 |
| Example 88 | 8.77 | 9.7 | 7.01 | 1.38 | 0.78 | 64 | 125.5 |
| Example 89 | 8.59 | 8.97 | 6.67 | 1.34 | 0.8 | 64 | 125.5 |
| Example 90 | 8.55 | 8.91 | 7.32 | 1.22 | 0.68 | 61 | 119.6 |
| Example 91 | 8.61 | 9.19 | 8.25 | 1.11 | 0.31 | 59 | 115.7 |
| Example 92 | 8.62 | 8.93 | 8.37 | 1.07 | 0.21 | 61 | 119.6 |
| Example 93 | 8.81 | 8.87 | 8.65 | 1.03 | 0.09 | 59 | 115.7 |
| Conparative Example 29 | 8.61 | 8.61 | 8.6 | 1.00 | 0.02 | 51 | 100.0 |
| Conparative Example 30 | 8.47 | 8.46 | 8.47 | 1.00 | 0.008 | 49 | - |
| Conparative Example 31 | 8.33 | 9.81 | 4.87 | 2.01 | 1.04 | 50 | - |
| Conparative Example 32 | 7.82 | 10.3 | 5.08 | 2.03 | 10.1 | 50 | - |

### Example 94

### Manufacture of Solid Electrolyte Layer Sheet-08

As the solid electrolyte layer sheet, the solid electrolyte sheet-08 manufactured by following method was used. The manufacturing method is that, first, in an argon atmosphere glove box, polyethylene oxide (PEO) having a molecular weight of 5 million and LiCF₃SO₃ (LiTFS) were dissolved and mixed in acetonitrile, and then dropped onto a Teflon sheet (“Teflon” is a registered trademark). After dropping a sheet was formed using a Teflon sheet as a base by a doctor blade method, and dried at room temperature for 24 hours, and vacuum dried at 60° C. to obtain a solid electrolyte layer sheet-08. In this case, by adjusting the thickness in the range of 5 to 15 µm, a plurality of solid electrolyte sheets-08 having different thicknesses were prepared.

### Manufacture of Positive Electrode Sheet

As the positive electrode active material, 100 parts of LiFePO₄, 10 parts of acetylene black, and 10 parts of polyvinylidene fluoride were weighed and dispersed in N-methylpyrrolidone as a solvent to obtain a slurry for a positive electrode. The obtained positive electrode slurry was applied to a part of one side of an aluminum foil having a thickness of 10 µm so as to have a thickness of 30 µm, and dried at 100° C. to remove the solvent. After removing the solvent, a slurry for a positive electrode is similarly applied to a part of the other surface of the aluminum foil to a thickness of 30 µm, and dried at 100° C. to remove the solvent to remove the aluminum. Active material layers were formed on both sides of the foil.

After forming the active material layer region on both sides of the aluminum foil, the material was rolled using a roll press and then punched to an electrode size of 27 mm × 30 mm using a die to prepare a positive electrode sheet. At this time, punching was performed so as to include a region in which a part of the active material layer did not exist.

### Manufacture of Negative Electrode Sheet

As the negative electrode active material, 100 parts of Li₄Ti₅O₁₂, 10 parts of acetylene black, and 10 parts of polyvinylidene fluoride were weighed as a negative electrode active material and dispersed in N-methylpyrrolidone as a solvent to obtain a slurry for a positive electrode. The obtained positive electrode slurry was applied to a part of one side of an aluminum foil having a thickness of 10 µm so as to have a thickness of 30 µm, and dried at 100° C. to remove the solvent. After removing the solvent, a slurry for a positive electrode is similarly applied to a part of the other surface of the aluminum foil to a thickness of 30 µm, and dried at 100° C. to remove the solvent to remove the aluminum. Active material layers were formed on both sides of the foil.

After forming the active material layer region on both sides of the aluminum foil, the material was rolled using a roll press and then punched to an electrode size of 28 mm × 31 mm using a die to prepare a negative electrode sheet. At this time, punching was performed so as to include a region in which a part of the active material layer did not exist.

### Manufacture of Laminate

The obtained 23 positive electrode sheets and 24 negative electrode sheets were laminated with a solid electrolyte sheet-08 interposed therebetween and pressure-bonded with a hot press at 50° C. to prepare a laminate. Further, aluminum leads were attached to each of the region where the positive electrode active material layer sheet did not exist and the region where the negative electrode active material layer sheet did not exist with an ultrasonic fusion machine. Next, this laminate was fused to an aluminum laminated film for an exterior body, and the electrode body was inserted into the exterior body by folding the laminate. Evaluation cell of Example 94 was produced by forming a closed portion by heat-sealing except for one side around the exterior body and sealing the opening with a heat seal while reducing the pressure with a vacuum sealing machine.

### Examples 95 to 102 and Comparative Examples 33 to 36

Examples 95 to 102 and Comparative Examples 33 to 36 were obtained in the same manner as in Example 94 except that the standard deviation σ of the average thickness of the solid electrolyte layer was changed by changing the solid electrolyte layer sheet-08 when the laminate was manufactured.

### Evaluation of Output Characteristics

The value t1, t2, and T, the obtained standard deviation σ of the solid electrolyte layers, and the evaluation result of output characteristics in Examples 94 to 102 and Comparative Examples 33 to 36 were shown in Table 10. It is noted that the evaluation of output characteristics was performed in the same conditions as the conditions in Example 40.

TABLE 10

| | average electrolyte thickness | t1 | t2 | t1/t2 | standard deviation σ(µm) | rate characteristics | rate characteristics improvement rate |
|---|---|---|---|---|---|---|---|
| | µm | µm | µm | | | %(1.0 C/0.2 C) | %(Example/ Comparative Example) |
| Example 94 | 8.65 | 10.6 | 5.99 | 1.77 | 10.30 | 59 | 120.4 |
| Example 95 | 8.68 | 10.8 | 5.45 | 1.98 | 0.92 | 57 | 116.3 |
| Example 96 | 8.66 | 9.89 | 6.48 | 1.53 | 1.03 | 60 | 122.4 |
| Example 97 | 8.77 | 9.7 | 7.01 | 1.38 | 0.78 | 61 | 124.5 |
| Example 98 | 8.59 | 8.97 | 6.67 | 1.34 | 0.8 | 60 | 122.4 |
| Example 99 | 8.55 | 8.91 | 7.32 | 1.22 | 0.68 | 57 | 116.3 |
| Example 100 | 8.61 | 9.19 | 8.25 | 1.11 | 0.31 | 55 | 112.2 |
| Example 101 | 8.62 | 8.93 | 8.37 | 1.07 | 0.21 | 55 | 112.2 |
| Example 102 | 8.81 | 8.87 | 8.65 | 1.03 | 0.09 | 56 | 114.3 |
| Comparative Example 33 | 8.61 | 8.61 | 8.6 | 1.00 | 0.02 | 49 | 100.0 |
| Comparative Example 34 | 8.47 | 8.46 | 8.47 | 1.00 | 0.008 | 49 | - |
| Comparative Example 35 | 8.33 | 9.81 | 4.87 | 2.01 | 1.04 | 47 | - |
| Comparative Example 36 | 7.82 | 10.3 | 5.08 | 2.03 | 10.1 | 47 | - |

From the results shown in Tables 5 to 9, superior output characteristics can be obtained by controlling the ratio of tl/t2 which is the ratio of an average thickness t1 of the thickest solid electrolyte layer to an average thickness t2 of the thinnest solid electrolyte layer. Further, from the results shown in Table 10, it can be confirmed that the output characteristics are similarly improved even when the form of the manufactured battery is different.

### Industrial Applicability

According to the present invention, a lithium ion secondary battery having high output characteristics can be provided. The above batteries are suitably used as a power source for portable electronic devices, and are also used as electric vehicles and household and industrial storage batteries.

### REFERENCE SIGNS LIST

1 Lithium ion secondary battery
20 Laminate
30 Positive electrode layer
31 Positive electrode current collector layer
32 Positive electrode active material layer
40 Negative electrode layer
41 Negative electrode current collector layer
42 Negative electrode active material layer
50 Solid electrolyte layer
60 Outer positive electrode
70 Outer negative electrode
80 Margin layer

1. A lithium ion secondary battery wherein
at least one positive electrode layer including a positive electrode active material layer and at least one negative electrode layer including a negative electrode active material layer are laminated in sequence with at least one solid electrolyte layer interposed therebetween, wherein
a ratio t1/t2 of an average thickness t1 of the thickest solid electrolyte layer to an average thickness t2 of the thinnest solid electrolyte layer satisfies 1.02 ≤ t1/t2 ≤1.99 when an average thickness of each of the solid electrolyte layer is defined as t.

2. The lithium ion secondary battery according to claim 1, wherein the standard deviation σ satisfies 0.15≤σ≤1.66 (µm).

3. The lithium ion secondary battery according to claim 1, further comprising an intermediate layer in at least one part between the positive layer or the negative layer and the solid electrolyte layer, which includes each constituent element of the positive layer or the negative layer and the solid electrolyte layer.

4. The lithium ion secondary battery according to claim 1, an average thickness T, which is an average of the average thickness t of each of the solid electrolyte layer, satisfying 4.8≤T≤9.8 (µm).
